(19) United States
(12) Patent Application Publication
(10) Pub. No.: US 2005/0216333 A1
(43) Pub. Date: Sep. 29, 2005

(54) DVD and entertainment distribution system and method

(76) Inventor: Alejandro Chouza, La Jolla, CA (US)

Correspondence Address: National IP Rights Center, LLC, Suite 400, 550 Township Line Road, Blue Bell, PA, 19422, US

(21) Appl. No.: 10/470,628

(22) Filed: Jan. 21, 2004

(51) Int. Cl. G06F 17/60

(52) U.S. Cl. 705/14

(57) ABSTRACT

A method for placing advertising on a DVD or comparable format such as “pay per view,” comprising the following steps: determining a demographic criterion for a DVD; choosing an advertisement related to that criterion and affixing it to the DVD; providing an end user with a choice to accept a DVD with advertising or not; downloading a DVD with advertising into the disk such that the advertising is played and cannot be edited.

### FIELD OF THE INVENTION

The invention is directed to a system for entertainment distribution on Digital Video Discs (DVDs). In particular, the present invention is directed to a system for making, pricing and distributing DVDs based upon a customer's willingness to accept paid advertising therefore.

### BACKGROUND OF THE INVENTION

Digital Video Disks (DVDs) have gained great popularity in recent years. By 2005, it is expected that DVDs will fully supplant the VHS market. DVDs provide a much clearer picture than the VHS format. Because of the nature of the DD technology, an opportunity has arisen for DVDs to be issued and sold so as to include non-suppressible advertising. VHS tapes have not fully maximized the concept of advertising. VHS systems and tapes can be easily fast forwarded or edited to avoid advertising and other commercial content. The DVD format provides a much better format for advertisers. The DVD format can be integrated with technology which makes it impossible to block efforts to bypass the advertising. For this reason, there is a market for DVD customers who are prepared to accept advertising in consideration for a greatly reduced price on the DVD.

A number of U.S. patents have already published or issued related to DVD technology. Published Application No. 2003/0138240 is directed to a DVD that includes a read-only ROM area in which video is previously recorded, and a readable/writable RAM area. A lender DVD apparatus writes a playback/recording control program in the RAM area of the DVD to be rented. A user DVD apparatus reads the playback/recording control program from the RAM area of the rented DVD. Following the playback/recording control program, the user DVD apparatus receives digital broadcasting, extracts CMs therefrom, and writes the extracted CMs in the RAM area. Then, the user DVD apparatus generates history data indicating how many times and which CM has been played-back, and writes the generated history data in the RAM area.

U.S. Pat. No. 5,909,638, to Allen discloses a system for capturing, storing and retrieving movies recorded in a video format and stored in a compressed digital format at a central distribution site. A plurality of remote distribution locations are connected through fiber optic connections to the central distribution site. The remote sites maybe of one of two types: a video retail store or a cable television (CATV) head end. In the case of a video retail store, VHS videotapes, other format videotapes or other video media may be manufactured on-demand in as little as three to five minutes for rental or sell-through. A totally automated manufacturing system is described in which the customers can preview and order movies for rental and sale from video kiosks. The selected movie is then either retrieved from local cache storage or downloaded from the central distribution site for manufacturing onto a blank or reused videotape. One feature of the system is the ability to write a two-hour videotape into a Standard Play (SP) format using a high speed recording device. A parallel compression algorithm based on the MPEG-2 format is used to compress a full-length movie into a movie data file of approximately four gigabytes of storage. The movie data file can be downloaded from the central site to the remote manufacturing site and written onto a standard VHS tape using a parallel decompression engine to write the entire movie at high speeds onto a standard VHS tape in approximately three minutes.

U.S. Pat. No. 5,625,570 is directed to a method and related system which allow for a series of individualized audio segments to be recorded for subsequent, simultaneous insertion into the audio track(s) of a plurality of videotapes loaded into multiple videotape recorders (VTR's), respectively. In one embodiment, each audio segment recorded is uniquely associated with, and inserted into, an audio track of a respective prerecorded videotape such that each of the plurality of videotapes is personalized with its own unique message. A voice recording and data entry station is provided wherein each audio segment to be inserted is independently recorded, digitized, and stored on a data tape with related identifying information associated therewith. Audio segments from the digital data tape are then downloaded in groups into a production control center computer, incorporating software and interface circuitry to control the operation of the VCR's, in order to effect the insertion of each audio message segment into respective videotapes. The production control center may further cause labels to be printed which may subsequently be affixed to particular videotapes. Such labels may identify the ultimate recipient of a particular personalized videotape and the respective videotape within the plurality of VTR's into which that recipients individualized audio segment has been inserted.

U.S. Pat. No. 6,574,424, to Dimitri et al discloses a method and apparatus for a randomizer for DVD video. A bit is provided in each Digital Video Disk memory sector header to indicate the type of information contained in the main data portion of the frame. A vector of video clips are stored on the DVD disk and the DVD drive examines the bit to determine whether to play a movie or to employ logic provided by the present invention that allows the DVD drive to determine which included video clip to play instead. The video clips may include cartoons, commercials, movie previews, etc. and the logic employed by the DVD drive allows for random or specific selections to be played at predetermined times, such as displaying a clip during the flipping process of a dual-sided DVD disk. Additionally, the method and apparatus may be applied to DVD disks to determine whether commercials are played before, after or during the movie or the movie is played commercial free.

U.S. Patent Application No. 2003/0170000 to Iwashita discloses a video playback control apparatus, content playback control apparatus, and method of supplying commercial information. A video data on the main part of a movie, which is long-time video data, is supplied from a DVD that is a disc medium. Plural sets of video data on trailers and commercials of a relatively short playing time are supplied from a distribution center via a subscriber telephone line or the like. A video playback control apparatus selects trailers and commercials in accordance with information on the distributor of the movie, the star actor/actress, the genre, etc., and conditions of the day of week, the time zone, etc., in which the movie is to be played back, and prepares a play schedule while combining the selected trailers and commercials. The whole movie including the selected trailers and commercials are played in accordance with the schedule.

U.S. Pat. No. 6,177,931, to Alexander et al., is directed towards systems and methods for displaying and recording control interface with television programs, video, advertising information and program scheduling information. The invention is an improvement over previous Electronic Programming Guides (“EPG”) in that it provides, among other things: Improved viewer interaction capabilities with the EPG; improved viewer control of video recording of future-scheduled programming; improved features to the EPG display and navigation; parental control of the EPG display; improved television program information access by the viewer; improved opportunities for the commercial advertiser to reach the viewer; improved product information access by the viewer; creation of a viewer's profile; utilization of viewer profile information to customize various aspects of the EPG; and utilization of viewer profile information to provide customized presentation of advertising to the viewer.

U.S. Pat. No. 6,496,981, to Weistendahl et al is directed towards a system for converting media content for interactive TV use. A system for allowing media content to be used as an interactive media program comprises: (a) media content in the form of successive image display frames indexed in a time sequence; (b) object mapping data specifying the locations of objects appearing in the display of media content which ate to be rendered interactive; (c) linkages provided through an associated interactive media program from the objects specified by the object mapping data to interactive functions to be performed upon selection of the objects in the display; and (d) a user system for operating the interactive media program in conjunction with the display of the media content by selecting an object appearing in an image display frame and performing the interactive function linked thereto. The invention includes an authoring system for generating the object mapping data for the media content. In a preferred interactive TV system, media content, in the form of movies, TV programs, advertising, and the like, can be presented as interactive media programs by transmitting the TV content with object mapping data (“hot spots”) to a set top box connected to a viewer's TV. The TV set top box has a utility stored therein for performing the interactive functions linked to the defined hot spots in the TV content upon user selection. Interactive TV programs can also be presented using a conventional TV set top box and remote control in conjunction with the current analog video content. For example, the analog video content may be transmitted to the viewer on a channel provided by a cable TV company, with the object mapping data and program linkages for interactive functions transmitted in the video blanking intervals (VBI) interleaved with the video frames.

U.S. Pat. No. 6,609,253, to Swix et al., is directed to a method and system for providing flexible subscriber VCR control of an interactive media system that limits the consumption of bandwidth capacity, the method comprising establishing a viewing time window during which a subscriber can watch an ordered program, enabling the subscriber to freely pause, rewind, and fast-forward the program so long as the end of the program does not exceed the end of the window, automatically tracking the remaining program running time against the time remaining in the window, deactivating the pause and rewind features if the remaining program running time equals the time remaining in the window, and reactivating the pause and rewind features if the program is fast-forwarded such that the time remaining in the window exceeds the remaining program running time. The system of the present invention is any interactive media system that delivers video streams such as an interactive television system that supports.

It would be desirable to provide a DVD system which would enable customers to accept advertising and other premiums in consideration for reduced or lower pricing.

It would be further desirable to provide a DVD system in which end user customers could select the level of advertising in return for a lower price.

It is therefore a principal object of the present invention to provide a system whereby consumers of DVDs can purchase DVDs atr a reduced price in consideration for the acceptance of advertising.

It is still a further object of the invention to provide a DVD advertising platform where advertising can be positioned using a letterbox format.

It is still a further object of the invention to provide a DVD and/or pay per view advertising platform in which the advertisements can be edited and incorporated in the presentation or entertainment.

It is still a further object of the present invention to provide a DVD and/or pay per view advertising system wherein the type of advertising selected can be based upon Demographical information provided by the customer or by a third party.

These and other objects of the present invention will become apparent from the summary and detailed description which follow.

### SUMMARY OF THE INVENTION

A method for placing advertising on a DVD or other pay per view format, comprising the following steps: determining a demographic criterion for a specific DVD based film; choosing an advertisement related to that criterion and affixing it to the DVD; providing an end user with a choice to accept or not accept the DVD with the advertising; providing the end user who chooses the advertising with the DVD with advertising such that the advertising appears and is shown on the DVD when it is played.

In further embodiments, the end user can select the quantity of advertising he is willing to accept. In addition, the may comprise a multimedia presentation interposed with the DVD film, a pictorial or written message appearing at the bottom of the DVD film when played, or a subliminal or direct message implanted within the DVD presentation so as to blend into the storyline of the DVD.

In a further embodiment, the invention is a method for placing advertising on a DVD, comprising the following steps: determining a demographic criterion for a DVD from a customer for the DVD; choosing an advertisement related to that criterion for affixation to the DVD; providing the end user with a choice to accept the DVD with one of plurality of potential levels of advertising; providing the end user with the DVD with advertising level so selected such that the advertising appears and is shown on the DVD when it is played.

In still yet a further embodiment, the invention is a method for placing advertising on a pay per view film, comprising the following steps: determining a demographic criterion for a pay per view film, from a customer for the film; choosing an advertisement related to that criterion for affixation to the pay per view film; providing the end user with a choice to accept the pay per view film with one of a plurality of potential levels of advertising; providing the end user with the pay per view film with the advertising level so selected such that the advertising appears and is shown on the pay per view film when it is played; and providing the end user with printed advertising and coupons.

### BRIEF DESCRIPTION OF THE DRAWINGS

FIG. 1 a perspective view of an overall system in accordance with the present invention.

FIG. 2 is a view of a database of the present invention.

FIG. 3 illustrates a customer profile screen in accordance with the present invention.

FIG. 4 illustrates the purchase screen in accordance with the present invention.

FIG. 5 illustrates a payment screen which factors in the percentage.

FIGS. 6a-6c illustrates the basic types of advertising formats envisioned by the present invention

### DETAILED DESCRIPTION OF THE PRESENT INVENTION

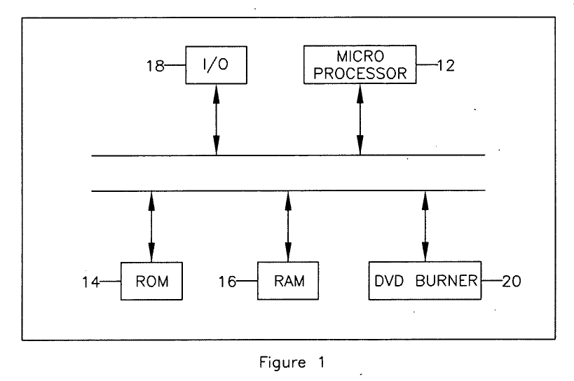

The present invention is described with reference to the enclosed figures wherein the same numbers are utilized. Referring to FIG. 1, the operating environment of the present invention is and describe disabled. As shown, the present invention comprises a system for downloading advertising onto a DVD so that the customer can get a cheaper or less expensive pricing options.

The basic features of the present invention are shown and discribed as follows. FIG. 1 illustrates the fundamental elements of the present invention which may be situated at a studio. As shown, the invention comprises a basic system having a microprocessor 12, ROM 14, RAM 16, I/O system 18 and DVD burner 20. The fundamental purpose of the system is to provide a mechanism for downloading advertisements on a DVD. The DVD is configured so that the advertising is placed at designated points throughout the DVD.

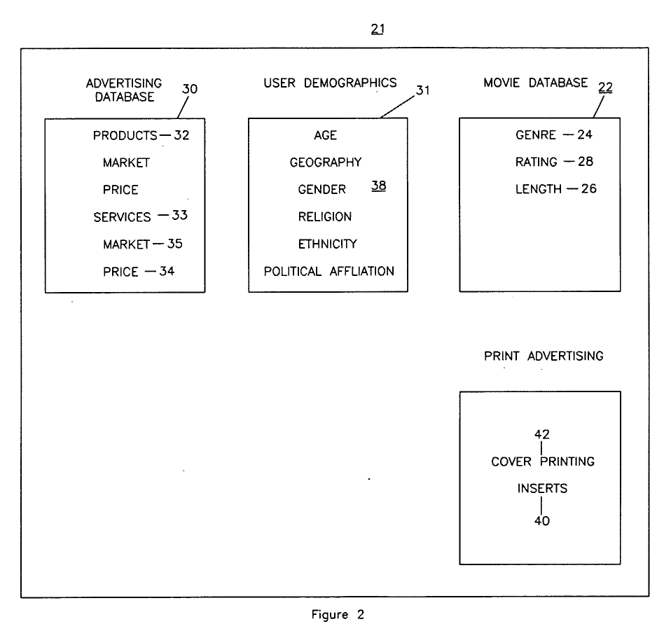

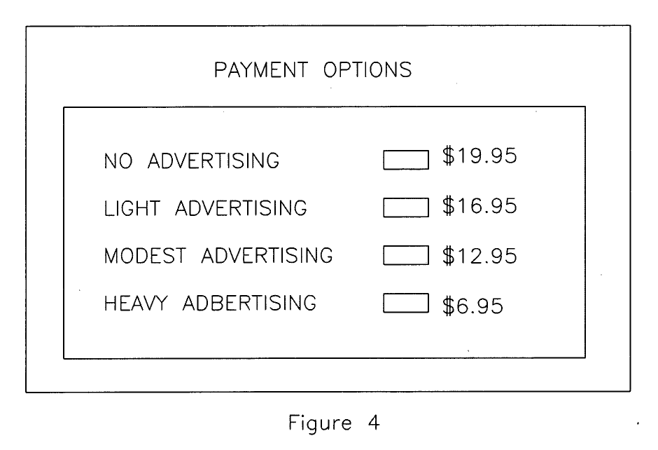

The ROM 16 stores a database (FIG. 2) 21 containing a plurality of movie titles and content 22 designated according to genre 24, length 26 and rating 28. An advertising database 30 stores a plurality of products and services 32, 33 designated by market 35, and price 34. The database further includes a user demographics database 36 which stores customer information according to agem geography, gender, religion, ethnicity, etc. 38. Finally, a print database stores a plurality of print advertisements 40, cover art 42 and inserts to be affixed to product. As shown in FIG. 4, the demographics are input via the end user who must complete a questionnaire 46 at the time of purchase, but may also be supplemented by third party data provided by advertisers, market research and movie studios.

The database thus stores a plurality of information related to movies and viewer demographics provided as noted above. The system functions by matching the advertising with the particular demographics of end users and the films or entertainment they watch. As noted, this data can be purchased independently or acquired through a series of users polls and questionnaires.

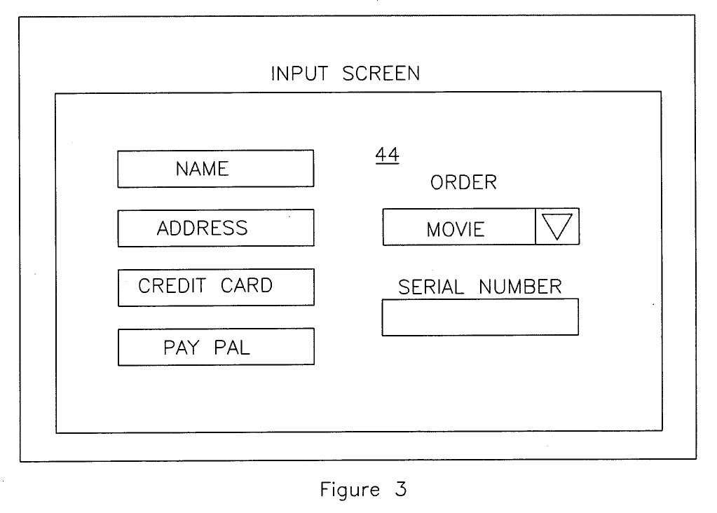

FIG. 3 illustrates a user screen to be used by an end user. The end user puts in his name and contact information 44. The end user then orders a movie either through a search function or by a serial number input function. The end user then chooses the movie he or she desires.

The end user then proceeds to a screen FIG. 4 which permits him to select the level of advertising he chooses he is willing to receive. In one embodiment, there are four levels of advertisement which can be selected: none, light, moderate and heavy 46a-d. Accordingly, the four price points are based upon the selected advertising level. The more advertising the end user is willing to accept, the lower his or her price.

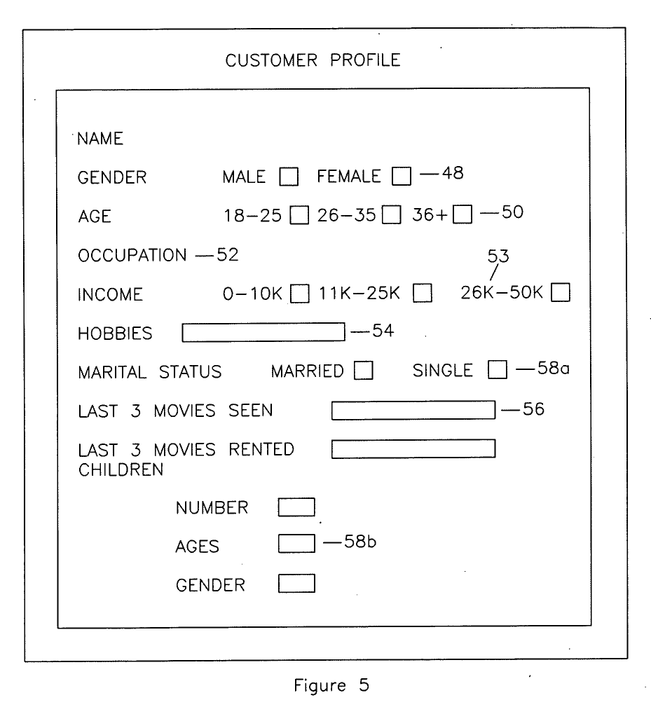

Referring to FIG. 5, a customer profile input screen is shown. The screen illustrates a series of questions which the consumer is required to answer such as gender 48, age 50, occupation 52, income 58, hobbies 54, movie viewing habits 56, and family make-up 58a, 58b. In this manner, advertising can be tailored to the end user. Hence, a young male adult who buys an action film may receive advertising for music, jeans or motorcycles.

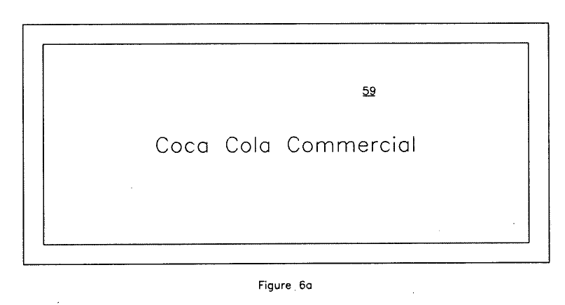

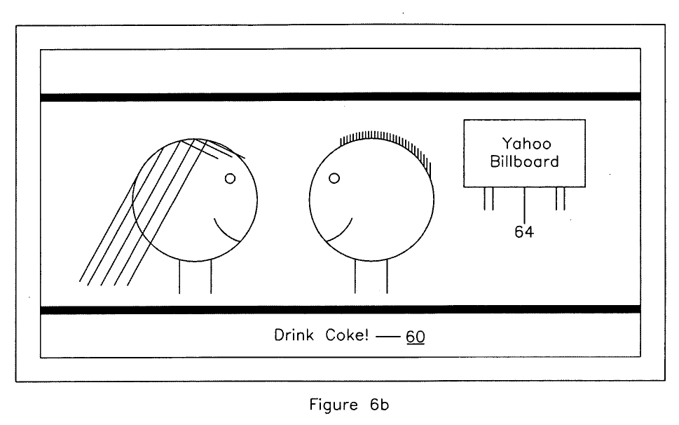

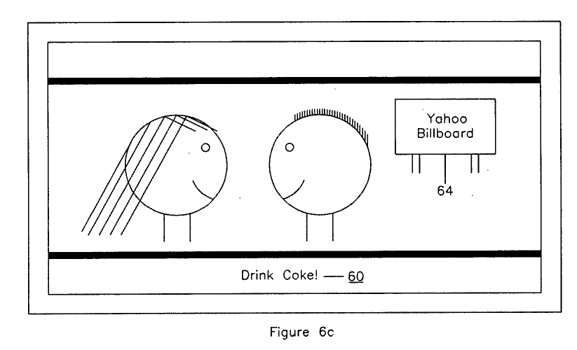

As shown in FIG. 6a to 6c, the system also allows for advertising of various type to placed in the DVD. For example as shown in FIG. 6a, the DVD technology allows for multimedia commercial announcements to be placed in the film 59. These announcements may be placed at specific intervals in the production. In addition, as shown in FIG. 6b, many movies and DVDs are produced using so-called letter-box format. This is a format which is designed to alleviate the problem of cropping used in the editing of wide screen films. Letter box format permits the entire screen to be shown but produces dark horizontal bands at the top and bottom of the screen. These areas which have been used for subttles and can similarly include advertising messages 60.

Finally as shown in FIG. 6c, the DVD process permits for the addition of subliminal advertising. A film taking place in a major city, for example, which may show billboards or buses and public transportation may be edited to include the advertising. For example, a scene in a movie showing a billboard may be digitally edited to appear on Billboard. (See Yahoo ad in the film edited for Coke in FIGS. 6b and 6c, 64, 65.)

The present invention thus provides a comprehensive system whereby end users can purchase DVDs at a reduced price in consideration for receiving advertised messages therein. While the present invention is specifically directed to DVDs, it is to be appreciated that the teachings of the invention are applicable to other formats including but not limited to pay per view. The present invention has been described with the reference to the above discussed preferred embodiment. It is to be appreciated that the true nature and scope of the present invention is to be determined with reference to the claims appended hereto.

1. A method for placing advertising on a DVD, comprising the following steps:
determining a demographic criterion for a specific DVD based film;
choosing an advertisement related to that criterion and affixing it to the DVD;
providing an end user with a choice to accept or not accept the DVD with the advertising;
providing the end user who chooses the advertising with the DVD with advertising such that the advertising appears and is shown on the DVD when it is played.

2. The method of claim 1 wherein the end user can select the quantity of advertising he is willing to accept.

3. The method of claim 1 wherein the advertising comprises a multimedia presentation interposed with the DVD film.

4. The method of claim 1 wherein the advertising comprises a pictoral or written message appearing at the bottom of the DVD film when played.

5. The method of claim 1 wherein the advertising comprises a subliminal or direct message implanted within the DVD presentation so as to blend into the storyline of the DVD.

6. A method for placing advertising on a pay per view presentation, comprising the following steps:
determining a demographic criterion for a pay per view presentation from a customer for the presentation;
choosing an advertisement related to that criterion for affixation to the presentation;
providing the end user with a choice to accept the presentation with one of plurality of potential levels of advertising;
providing the end user with the presentation with advertising level so selected such that the advertising appears and is shown on the presentation when it is played.

7. A method for placing advertising on a DVD, comprising the following steps:
determining a demographic criterion for a DVD from a customer for the DVD;
choosing an advertisement related to that criterion for affixation to the DVD;
providing the end user with a choice to accept the DVD with one of plurality of potential levels of advertising;
providing the end user with the DVD with the advertising level so selected such that the advertising appears and is shown on the DVD when it is played; and
providing the end user with printed adverting and coupons contained within the DVD based upon the criterion.
